(19) United States
(12) Patent Application Publication
(10) Pub. No.: US 2021/0315221 A1
(43) Pub. Date: Oct. 14, 2021

(54) USE OF A CATIONIC POLYSACCHARIDE COMPOUND AS A FUNGICIDE, PESTICIDE, ALGAECIDE, DESSICANT AND FOR EXTENDING THE SHELF LIFE OF FRUITS AND VEGETABLES

(71) Applicant: Bayer Aktiengesellschaft, Leverkusen (DE)

(72) Inventors: Johan KIJLSTRA, Odenthal (DE); Jan-Henrik LENTHE, Mettmann (DE)

(21) Appl. No.: 17/264,464

(22) PCT Filed: Jul. 30, 2019
(86) PCT No.: PCT/EP2019/070449

§ 371 Date: Jan. 29, 2021

(30) Foreign Application Priority Data
Jul. 31, 2018 (EP) 18186456.2

(51) Int. Cl. A23B 7/154; A01N 43/16; A01N 25/02

(52) U.S. Cl. CPC A23B 7/154; A01N 25/02; A01N 43/16

(57) ABSTRACT

The invention relates to the use of known cationic polysaccharide compounds as fungicides, pesticides, algaecides, dessicants and for extending the shelf life of fruit and vegetables.

The invention relates to the use of known cationic polysaccharide compounds as fungicides, pesticides, algaecides, dessicants and for extending the shelf life of fruit and vegetables.

It is known that synthetic cationic polymers can be used for biocidal applications.

For example, the use of polyethylenimine biocides for consumer products, coatings, coating compositions and medical devices to prevent growth of microorganisms has been described by US 2011/0171279 A1. Polyethylenimine polymers are branched, spherical polymeric amines with a high charge density, which enable them to adsorb tightly on negatively charged surfaces.

Polymers based on diallyldimethyl ammonium chloride (polyDADMAC) presents another example of highly charged synthetic polymers. The molecular weight of commercial polyDADMAC products is typically in the range of hundreds of thousands of grams per mole, and even up to a million for some products. WO2004/076770 A1 describes polyDADMAC as antifungal agents.

WO2005/018326 A1 describes amino functionalised fungicidal polymers of typical high molecular weight (preferably 30 kDa and more) obtained by polymerization of acrylic monomers to combat phytopathogenic fungi.

Due to their chemical properties (high cationic charge density, high molecular weight), these synthetic polycations are, however, generally not only toxic to mammals and aquatic life but also poorly biodegradable. This limits their use of such synthetic cationic polymers for agrochemical uses.

Chitosan, a cationic linear polysaccharide composed of randomly distributed β-(1->4)-linked D-glucosamine (deacetylated unit) and N-acetyl-D-glucosamine (acetylated unit), is a natural polymer which has been described for agrochemical uses (e.g. by Abdelbasset El Hadrami et al., Mar. Drugs 2010, 8, 968-987). Being derived from a natural polymer (chitin), chitosan is a non-toxic, biocompatible and biodegradable polymer. The Environmental Protection Agency EPA concluded in 2008 that there are no major identifiable risks to human health of chitin and chitosan products. However, in spite of these advantages, some product properties limit the use of chitosan as an agrochemical. One disadvantage is related to the poor solubility of chitosan under neutral and alkaline conditions. One of the reasons for this insolubility lies in the rigid crystalline structure and primary amino group residues, which take part in hydrogen bonding. Its solubility is limited at a pH higher than 6.5 where chitosan starts to lose its cationic nature. At lower pH values, the solubility increases due protonation of the primary amino groups. At these lower pH values however, to its high molecular weight, chitosan not only starts to dissolve, but also acts as a thickener. Even at lower concentrations, it increases the viscosity of aqueous solutions significantly. As a consequence, for commercial products with good handling properties, only aqueous formulations with low chitosan contents are feasible (a few percent maximum). This, however, limits the biological efficacy of Chitosan.

In light of the prior art it was an objective of the present invention to provide environmentally friendly polymers that can be used for agricultural purposes, are easy to formulate and provide sufficient biological efficacy.

The objective of the present invention has been solved by the use of a cationic polysaccharide compound which contains, per monosaccharide unit, on average at least 0.1 cationic group of the formula:

-A-N⁺R¹R²R³ or —C(═NR⁴)—NR¹R²

in which formula:

“A” represents a straight-chain or branched C₂-C₆ alkylene group which is optionally preceded by a carbonyl group or optionally interrupted by one or two oxygen atoms or imino or alkylimino groups and optionally substituted by one or two hydroxyl groups or amine groups or a carboxyl or carbamoyl group; or “A” represents the residue of a monosaccharide unit;

R¹ and R² each represent hydrogen methyl, carboxymethyl, phosphonomethyl, ethyl, hydroxyethyl, propyl, isopropl, allyl, hydroxypropyl or dihydroxypropyl or, together with the nitrogen atom, form a pyrrolidino, piperidino, piperazino, N′-alkylpiperazino, N′-(hydroxyalkyl)piperazino, N′-(aminoalkyl)piperazino, morpholino or hexamethyleneamino group;

R³ represents hydrogen, C₁-C₁₈ alkyl, C₃-C₁₈ alkenyl, alkynyl or cycloalkyl, C₄-C₁₈ cycloalkyl-alkyl or C₇-C₁₈ aralkyl or a group of the formula -A-Fruc, where “A” has the above-mentioned meaning and “Fruc” represents a polysaccharide residue bonded via oxygen; and

R⁴ represents hydrogen, methyl, ethyl, hydroxyethyl, hydroxypropyl or dihydroxypropyl; where the amine nitrogen atoms can be uncharged or protonated or quarternised with methyl, ethyl, hydroxyethyl, hydroxypropyl or dihydroxypropyl.

as a fungicide, pesticide, algaecide, dessicant and/or for extending the shelf life of fruits and/or vegetables and wherein the cationic derivate of the polysaccharide has a solubility in water of at least 20 wt-% at a temperature of 25° C., preferably at least 30 wt-%.

Cationic fructan compounds as e.g. described in WO98/14482 A1 are known to be useful as auxiliaries in papermaking, water treatment, sludge treatment, in cosmetics, as disinfectants, hair conditioners, flocculants, shale inhibitors, corrosion inhibitors, demulsifiers, adhesive textile auxiliaries, or as additives in building, ceramics or plastics. However, agricultural and environmental science uses such as vector control, professional pest control management, forestry, turf and ornamental for cationic fructan compounds have not yet been described.

In comparison to known biological polymers such as chitosan the cationic polysaccharide compounds of the invention are easy to formulate as they are not specifically sensitive to certain pH-values.

A preferred embodiment of the invention relates to the use of a cationic polysaccharide compound which is selected from the group consisting of sucrose, trehalose, lactose, fructan, dextran, maltodextrin, amylose and cellulose

and wherein each polysaccharide contains, per monosaccharide unit, on average at least 0.1 cationic group of the formula:

-A-N⁺R¹R²R³ or —C(═NR⁴)—NR¹R²

and wherein the group A, R¹, R², R³, R⁴ are defined as described herein.

Another preferred embodiment of the invention relates to the use of a cationic polysaccharide compound which has a cationic group of the formula: -A-N⁺R¹R²R³.

Another particularly preferred embodiment of the invention relates to the use of a polysaccharide compound which is fructan and which contains, per monosaccharide unit, on average at least 0.1 cationic group of the formula:

-A-N⁺R¹R²R³

and wherein the group A, R¹, R², R³ are defined as described herein.

The degree of substitution (DS) describes the number of cationic compounds per monosaccharide unit, which relates to the charge density of the cationic polymer.

Another embodiment of the invention relates to the above described polysaccharide compound which preferably contains, per monosaccharide unit, on average from 0.1 to 2.5, more preferably on average from 0.2 to 2.0 and especially preferred from 0.35 to 1.5 cationic group.

In this context “cationic” compounds are understood to be nitrogen compounds which are intrinsically cationic (quaternary ammonium compounds) or which are cationic only in an acid medium (primary, secondary or tertiary amine compounds). The natural amines corresponding to the ammonium compounds therefore always fall under the same concept.

In a preferred embodiment of the invention the cationic polysaccharide compounds have an average chain length (=degree of polymerization, DP) of at least 2 up to about 1.000, in particular from 3 up to about 60. The preferred average chain length for other uses is from 3 to 15 monosaccharide units.

In a preferred embodiment of the invention the polysaccharide compounds are understood to be fructan compounds which are all oligosaccharides and polysaccharides which have a multiplicity of anhydrofructose units. These fructans can have a polydisperse chain length distribution and can be straight-chain or branched. The fructans comprise both products obtained directly from a vegetable or other source and products in which the average chain length has been modified (increased or reduced) by fractionation, enzymatic synthesis or hydrolysis. The fructans have an average chain length (=degree of polymerisation, DP) of at least 2 up to about 1.000, in particular from 3 up to about 60. For some uses, the preferred average chain length is at least 8, in particular at least 15 or even at least 25 monosaccharide units. The preferred average chain length for other uses is from 3 to 15 monosaccharide units. Preferably, the fructan as used according to the invention contains predominantly β-2,1 bonds, as in inulin (see also Mensink et al., Carbohydrate Polymers 130 (2015) 405-419). Inulin can be obtained from, for example, chicory, dahlias and Jerusalem artichokes.

Fractionation of fructans such as inulin can be achieved by, for example, low temperature crystallisation (see WO 96/01849 A1), separation by column chromatography (see WO 94/12541 A1), membrane filtration (sec EP-A-440074 A and EP-A-627490 A) or selective precipitation with an alcohol. Other fructans, such as long-chain fructans which, for example, are obtained on crystallisation, fructans from which monosaccharides and disaccharides have been removed and fructans in which the chain length has been lengthened enzymatically, can also be converted to cationic compounds. Prior hydrolysis to obtain shorter fructans can be carried out, for example enzymatically (endoinulinase), chemically (water plus acid) or by heterogenous catalysis (acid ion exchange resin). Alternatively or additionally, crosslinked fructans can be used for producing cationic compounds. Reduced fructans can also be used. Reduced fructans are fructans in which reducing terminal groups (usually fructose groups) have been reduced, for example using sodium borohydride or using hydrogen in the presence of a transition metal catalyst.

Furthermore, hydroxyalkylated, carboxymethylated and oxidised fructans can also serve as the basis for cationic compounds. Hydroxyalkylated and carboxymethylated fructans can be obtained by reaction of the fructan with, respectively, ethylene oxide or another alkylene oxide (see EP-A-638589 A) and chloroacetic acid, preferably in an aqueous medium with a base. Oxidised fructans are fructans which have been converted by treatment with, for example, hypochlorite or periodate and/or chlorite into compounds which contain carboxyl and/or aldehyde groups. The introduction of cationic groups into fructan compounds containing carboxyl groups leads to amphoteric compounds which have interesting properties. A modified inulin which is particularly suitable for conversion to a cationic compound is a reduced dialdehyde-inulin. When dialdehyde-inulin is reduced, for example with hydrogen in the presence of a transition metal or with sodium borohydride, a polyol (poly-α-hydroxymethyl-α-[2-hydroxy-1-(hydroxymethyl)-ethoxy]ethylene oxide) is produced which contains a large number of primary hydroxyl groups. These polyols can be converted to cationic compounds. Alternatively, dialdehydeinulin can be reductively aminated (in one step or two steps) using conventional reducing agents to produce the polyol indicated above wherein one or more hydroxymethyl groups are replaced by (substituted) aminomethyl groups, which may subsequently be quaternised. Amines to be used in the reductive amination include ammonia and primary C₁-C₆ alkylamines and alkylenediamines.

Examples of straight-chain or branched C₂-C₆ alkylene groups which are optionally preceded by a carbonyl group or optionally interrupted by one or two oxygen atoms or optionally alkylated and/or protonated imino groups and which are optionally substituted by one or two hydroxyl groups or amine groups or a carboxyl or carbamoyl group are ethylene, 1,2-propylene, 1,3-propylene, 2-hydroxy-1,3-propylene, tetramethylene, hexamethylene, 2,2-dimethyl-1,3-propylene, 2-butenylene, 2-butynylene, 2,4-hexadienylene, cyclohexylene, N-methyliminodiethylene, diiminotriethylene, oxydiethylene, oxydipropylene, ethyleneiminocarbonylmethylene, carbonylethylene and carboxyethylene. Compounds containing a 3-aminopropyl group or a 3-carboxymethyl-aminopropyl group also form part of the invention. Such compounds have been described in International Patent Applications WO96/34017 A1 and WO98/06756 A1.

A preferred embodiment of the invention relates to the above described polysaccharide compound, wherein the polysaccharide compound is characterized in that “A” is bonded to an oxygen atom of the monosaccharide unit.

Another preferred embodiment relates to the above described polysaccharide compound, wherein the polysaccharide compound is characterized in that R¹ and R² each represent methyl or ethyl.

A further preferred embodiment relates to the above described frutan compound, wherein the polysaccharide compound is characterized in that “A” represents ethylene or 2-hydroxypropylene.

Preferably the polysaccharide compound as used according to the invention are further characterized in that R¹, R² and R³ each represent methyl or ethyl.

In another preferred embodiment of the invention “A” represents a 2-hydroxy-1,3-propylene group.

Herein preferably described cationic polysaccharide resp. fructan compounds are based on inulin, i.e. chemically modified cationic inulin and particularly preferred hydroxypropyl trimonium inulin (CAS-no. 205131-94-8), which is commercially available. Cosun Biobased Products for example offers a series of cationic inulines with different degree of substitution or varying charge density under their tradename QUATIN. These bio-sourced and chemically enhanced products come as aqueous solutions with high solid contents (>35 w % active material), are inherent biodegradable, not classified as hazardous and are not toxic to aquatic life.

In addition, the herein described cationic fructan compounds can be prepared according to known processes such as e.g. described in detail in WO 98/14482 A1.

Cationic polysaccharide (preferably fructan) compounds containing groups of formula -A-N⁺R¹R²R³, where “A” represents ethylene or 1,2-propylene, can, for example, be obtained by a reaction of the—optionally modified—polysaccharide (preferably fructan) with an ethyleneimine (aziridine) substituted in the correct manner on a nitrogen, or 1,2-propyleneimine or aminoethyl halide or 2-aminopropyl halide with a base in an organic solvent or preferably in water. When “A” represents 2-hydroxy-1,3-propylene, the reaction can be carried out with a glycidylamine or a 3-halo-2-hydroxypropylamine or a corresponding ammonium salt. When “A” contains a carbamoyl or carboxyl group as a substituent, the reaction can be carried out with a 2-dialkylamino-3-halopropionamide or 2-dialkylamino-3-halopropionic acid. When “A” represents 2-butenylene an unsubstituted or substituted 4-chloro-2-butenylamine can be used. Other suitable reagents are 2-chloropropyldimethylamine, N-(2-chloroethyl)-morpholine, 3-bromopropyl-trimethylammonium bromide, chloroethyldiethylamine, 4-chloro-1-methyl-piperidine, and the like.

Polysaccharide (preferably fructan) compounds in which “A” represents an alkylene group interrupted by oxygen atoms or imine groups can be obtained analogously, for example using a reagent of the formula X—CH₂—CH₂—[Y—CH₂—CH₂]ₙ—N⁺R¹R²R³ (X═Cl, Br and the like, Y═O, NH, NCH₃, n=1 or 2). Where Y═O and n=1 the polysaccharide (preferably fructan) compounds can also be obtained by reaction of the polysaccharide (preferably fructan) with an alkylene oxide to give a hydroxyalkylpolysaccharide (preferably a hydroxyalkylfructan) with a high degree of substitution, followed by reaction with a β-haloamine of the formula X—CH₂—CH—N⁺R¹R²R³. Polysaccharide (preferably fructan) compounds in which “A” has the formula —C(═NR⁴)—NR¹R² (iminocarbamoyl) can be obtained by reaction of the polysaccharide (preferably fructan) with cyanamide or an N-substituted cyanamide. One of the nitrogen atoms in the iminocarbamoyl group can have been protonated or have been quaternised, for example with methyl.

Polysaccharide (preferably fructan) compounds of the above-mentioned formula in which R³ represents -A-Fruc are cross-linked derivatives which can be obtained by reaction of the polysaccharide (preferably fructan) with an amine containing two or three coupling functional groups, such as N,N-bis- or N,N,N-tris-(2-chloroethyl)amine, N,N-bis- or N,N,N-tris-(3-chloro-2-hydroxypropyl)amine and N,N′-bis(2-chloroethyl)piperazine. Any 2-chloroethyl or 3-chloro-2-hydroxypropyl groups remaining after the coupling reaction can simply be hydrolysed to 2-hydroxyethyl or 2,3-dihydroxypropyl groups, respectively.

A review of synthesis methods for cationic derivatives of starch is given in Chapter 8, “Preparation of Cationic Starches” by D. D. Solarck in “Modified Starches, Properties and Uses”, Ed. O. B. Wurzburg, CRC Press, 1986, pp. 114-121, which methods are generally usable for the preparation of the polysaccharide compounds in question.

In general it is preferred to carry out the preparation of the polysaccharide compounds according to the invention in an aqueous medium, if appropriate in the presence of a base.

Depending on the desired degree of substitution it is possible to use, in this reaction, for example 0.1-10 equivalents, in particular 0.2-5 equivalents, of the amine reagent concerned, which equivalents are based on the number of monosaccharide units (for fructan preferably the anhydrofructose units in the fructan).

The reaction can be carried out at room temperature, but preferably at an elevated temperature of 30°-150° C. The reaction times are usually between a few minutes and a few hours, depending on the temperature. After the reaction has gone to completion, the reaction mixture is neutralised and, partly depending on the intended use, worked up. If the polysaccharide (preferably the fructan) compound has to be free from salts and residual reagent or hydrolysis products thereof (such as hydroxyalkylamines) for the intended use, known purification techniques can be used such as electrodialysis, nanofiltration and precipitation with an alcohol, such as ethanol.

A particularly advantageous process for preparing the present polysaccharide (preferably fructan) derivatives involves a reaction carried out under conditions of elevated temperature, intensive kneading and a small amount of solvent, such as those which prevail in an extrusion reactor. An example of such conditions for the preparation of starch derivatives is described by Meuser et al., Starch/Staerke 42 (1990), 330-360.

With an extrution preparation method it is possible, for example to meter the polysaccharide (preferably fructan) into the extruder in solid form and, in addition, to meter the base (sodium hydroxide solution) and amine reagent (for example 3-chloro-2-hydroxypropyl-trimethylammonium chloride) into the extruder in the form of a concentrated solution. With this procedure the solids content is preferably greater than 25% and in particular greater than 50% up to close to 100%. The temperature can, for example, be chosen between 60° and 150° C. Under these conditions a significant shortening of the reaction time is obtained and, furthermore, high efficiency is achieved.

If desired, the cationic polysaccharide (preferably fructan) compounds can then be further modified. As already stated, the neutral amines can be converted to the acid addition salts, such as hydrochlorides, hydrobromides, sulphates, phosphates acetates and the like. Derivatives containing a primary, secondary or tertiary amine group can be converted to further N-alklated and optionally quaternary derivatives using conventional alkylating agents such as dimethyl sulphate, ethyl bromide, chloroethanol, alkyl chloride, benzyl chloride, and the like. Other modifications of the cationic polysaccharide (preferably fructan) compounds as used according to the invention are also possible, such as oxidation with, for example, hypochlorite, periodic acid or hydrogen peroxide, carboxyl groups being formed. The derivatives can also be carboxymethylated with, for example, chloroacetic acid or sulphoalkylated with, for example, propylene sulphone. Such modifications are preferably carried out in such a way that the degree of substitution by the groups introduced in this way, such as carboxyl groups, is lower than the degree of substitution by amine or ammonium groups.

The term “fungicide” as used according to the invention means the capacity of a substance to increase the mortality or inhibit the growth rate of fungi.

The cationic polysaccharide compounds of the invention are preferably used to curatively or preventively (preferably at least preventively) control phytopathogenic fungi wherein the use comprises applying to the plant, to a part of the plant and/or to a locus of the plant the cationic polysaccharide compounds of the invention.

The term “phytopathogenic fungi” stands for all fungal and chromista organisms which cause damages on plants or any part of a plant. Examples for fungal organisms are Ascomycota, Basidiomycota, Chytridiomycota, Deuteromycota, Glomeromycota, Microsporidia, Zygomycota, and anamorphic fungi. Examples for Chromista are Oomycota.

In a preferred embodiment of the invention the cationic polysaccharide compounds of the invention are used to curatively or preventively control Ascomycota.

Among the diseases of plants or crops that can be controlled by the method according to the invention, mention may be made of:

Powdery Mildew Diseases such as Blumeria diseases caused for example by Blumeria graminis; Podosphaera diseases caused for example by Podosphaera leucotricha; Sphaerotheca diseases caused for example by Sphaerotheca fuliginea; Uncinula diseases caused for example by Uncinula necator; Rust Diseases such as Gymnosporangium diseases caused for example by Gymnosporangium sabinae; Hemileia diseases caused for example by Hemileia vastatrix; Phakopsora diseases caused for example by Phakopsora pachyrhizi and Phakopsora meibomiae; Puccinia diseases caused for example by Puccinia recondite, and Puccinia triticina; Uromyces diseases caused for example by Uromyces appendiculatus; Oomycete Diseases such as Bremia diseases caused for example by Bremia lactucae; Peronospora diseases caused for example by Peronospora pisi and Peronospora brassicae; Phytophthora diseases caused for example by Phytophthora infestans; Plasmopara diseases caused for example by Plasmopara viticola; Pseudoperonospora diseases caused for example by Pseudoperonospora humuli and Pseudoperonospora cubensis; Pythium diseases caused for example by Pythium ultimum; Leafspot, Leaf blotch and Leaf Blight Diseases such as Alternaria diseases caused for example by Alternaria solani; Cercospora diseases caused for example by Cercospora beticola; Cladiosporium diseases caused for example by Cladiosporium cucumerinum; Cochliobolus diseases caused for example by Cochliobolus sativus (Conidiaform: Drechslera, Syn: Helminthosporium); Colletotrichum diseases caused for example by Colletotrichum lindemuthianum; Cycloconium diseases caused for example by Cycloconium oleaginum; Diaporthe diseases caused for example by Diaporthe citri; Elsinoe diseases caused for example by Elsinoe fawcettii; Gloeosporium diseases caused for example by Gloeosporium laeticolor; Glomerella diseases caused for example by Glomerella cingulata; Guignardia diseases caused for example by Guignardia bidwellii; Leptosphaeria diseases caused for example by Leptosphaeria maculans; Magnaporthe diseases caused for example by Magnaporthe grisea; Mycosphaerella diseases caused for example by Mycosphaerella graminicola and Mycosphaerella fijiensis; Phaeosphaeria diseases caused for example by Phaeosphaeria nodorum; Pyrenophora diseases caused for example by Pyrenophora teres; Ramularia diseases caused for example by Ramularia collo-cygni; Rhynchosporium diseases caused for example by Rhynchosporium secalis; Septoria diseases caused for example by Septoria apii; Typhula diseases caused for example by Thyphula incarnate; Venturia diseases caused for example by Venturia inaequalis; Root- and Stem Diseases such as Corticium diseases caused for example by Corticium graminearum; Fusarium diseases caused for example by Fusarium oxysporum; Gaeumannomyces diseases caused for example by Gaeumannomyces graminis; Rhizoctonia diseases caused for example by Rhizoctonia solani; Oculimacula (Tapesia) diseases caused for example by Oculimacula Tapesia acuformis; Thielaviopsis diseases caused for example by Thielaviopsis basicola; Ear and Panicle Diseases including Maize cob such as Alternaria diseases caused for example by Alternaria spp.; Aspergillus diseases caused for example by Aspergillus flavus; Cladosporium diseases caused for example by Cladiosporium cladosporioides; Claviceps diseases caused for example by Claviceps purpurea; Fusarium diseases caused for example by Fusarium culmorum; Gibberella diseases caused for example by Gibberella zeae; Monographella diseases caused for example by Monographella nivalis; Smut- and Bunt Diseases such as Sphacelotheca diseases caused for example by Sphacelotheca reiliana; Tilletia diseases caused for example by Tilletia caries; Urocystis diseases Urocystis occulta; Ustilago diseases caused for example by Ustilago nuda; Fruit Rot and Mould Diseases such as Aspergillus diseases caused for example by Aspergillus flavus; Botrytis diseases caused for example by Botrytis cinerea; Penicillium diseases caused for example by Penicillium expansum and Penicillium purpurogenum; Sclerotinia diseases caused for example by Sclerotinia sclerotiorum; Verticillium diseases caused for example by Verticillium alboatrum; Seed- and Soilborne Decay, Mould, Wilt, Rot and Damping-off diseases; Fusarium diseases caused for example by Fusarium culmorum; Phytophthora diseases caused for example by Phytophthora cactorum; Pythium diseases caused for example by Pythium ultimum; Rhizoctonia diseases caused for example by Rhizoctonia solani; Sclerotium diseases caused for example by Sclerotium rolfsii; Canker, Broom and Dieback Diseases such as Nectria diseases caused for example by Nectria galligena; Blight Diseases such as Monilinia diseases caused for example by Monilinia Taxa; Leaf Blister or Leaf Curl Diseases including deformation of blooms and fruits such as Taphrina diseases caused for example by Taphrina deformans; Decline Diseases of Wooden Plants such as Esca disease caused for example by Phaeomoniella clamydospora and Phaeoacremonium aleophilum and Fomitiporia mediterranea; Diseases of Flowers and Seeds such as Botrytis diseases caused for example by Botrytis cinerea; Diseases of Tubers such as Rhizoctonia diseases caused for example by Rhizoctonia solani; Helminthosporium diseases caused for example by Helminthosporium solani; Diseases caused by Bacterial Organisms such as Xanthomanas species for example Xanthomonas campestris pv. Oryzae; Pseudomonas species for example Pseudomonas syringae pv. Lachrymans; Erwinia species for example Erwinia amylovora.

Plants or parts thereof to be treated with the cationic polysaccharide compound of the invention are preferably selected from the group consisting of citrus, pome fruits, stone fruits, tropical fruits, nuts, oilseed rape, berries, vegetables; cereals such as wheat, barley, oats, rye; cotton, sunflower, grape, tea, coffee, maize, rice; legumes including lentils, garbanzos and soybean, ornamentals and turf.

Citrus is a common term and genus (Citrus) of flowering plants in the rue family, Rutaceae. The term Citrus includes orange (C. sinensis), lemon (C. limon), grapefruit (C. paradisi), and lime (various, mostly C. aurantifolia, the key lime).

Pome is a common term for fruits produced by flowering plants in the subtribe Malinae of the family Rosaceae and for plants producing these fruits. A pome is an accessory fruit composed of one or more carpels surrounded by accessory tissue. Examples of plants that produce fruit classified as a pome are apple, loquat, pear, Pyracantha, and quince.

Vegetable as used herein refers to an edible plant or its part selected from the list consisting of flower bud vegetable such as broccoli, cauliflower, globe artichokes and capers; leaf vegetable such as kale, spinach (Spinacia oleracea), arugula (Eruca sativa), and lettuce (Lactuca sativa); stem vegetable such as kohlrabi; stem shoot vegetable such as asparagus, bamboo shoots, potatoes (Solanum tuberosum L) and sweet potatoes (Ipomoea batatas); root vegetable such as carrots (Daucus carota), parsnips (Pastinaca sativa), beets (Beta vulgaris), and radishes (Raphanus sativus); bulb vegetable such as onion, garlic and shallots of genus Allium; tomato (Solanum lycopersicum), cucumber (Cucumis sativus), zucchini, squash and pumpkin of genus species Cucurbita pepo, pepper (of family Solanaceae), eggplant; beans (Phaseolus vulgaris).and pea (Pisum sativum).

Stone fruit are all species of the Prunus genus. Examples of plants that produce fruit classified as a stone fruit are e.g. peaches, nectarines, plums, apricots, and cherries. Subtropical and tropical fruit are fruit produced by plants native to the geographical and climatic region of the subtropics or tropics. Examples of plants that produce fruit classified as a subtropical or tropical fruit are e.g avocado, banana, cherimoya, date, dragon fruit, durian, fig, guava, jackfruit, kiwi, lychee, mango, mangosteen, passion fruit, papaya, pineapple, persimmon, pomegranate, rambutan and star fruit. Nuts are referring to any hard-walled, edible kernel such as e.g. almonds, Brazil nuts, cashews, hazelnuts, macadamias, peanuts, pecans, pine nuts, pistachios and walnuts.

Berries are any small edible fruit usually juicy, round, brightly coloured, sweet or sour, and do not have a stone or pit, although seeds may be present as e.g. blackberry, blueberry, cranberry, currant, elderberry, gooseberry, grape, raspberry, strawberry.

Ornamentals are plants grown for decorative purposes in gardens and landscape design, as houseplants, for cut flowers and specimen display, e.g. roses, chrysanthemums, tulips, etc.

In a very preferred embodiment of the invention the cationic polysaccharide compounds are used to curatively or preventively (preferably at least preventively) control powdery mildew.

The term “pesticide” as used according to the invention refers to the capacity of a substance to kill or cause a knockdown of a pest.

The cationic polysaccharide compounds of the invention are active against normally sensitive and resistant species and against all or some stages of development. The abovementioned pests include:

Pests from the phylum of the Arthropoda, in particular from the class of the Arachnida, for example Acarus spp., for example Acarus siro, Aceria kuko, Aceria sheldoni, Aculops spp., Aculus spp., for example Aculus fockeui, Aculus schlechtendali, Amblyomma spp., Amphitetranychus viennensis, Argas spp., Boophilus spp., Brevipalpus spp., for example Brevipalpus phoenicis, Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., for example Eotetranychus hicoriae, Epitrimerus pyri, Eutetranychus spp., for example Eutetranychus banksi, Eriophyes spp., for example Eriophyes pyri, Glycyphagus domesticus, Halotydeus destructor, Hemitarsonemus spp., for example Hemitarsonemus latus (=Polyphagotarsonemus latus), Hyalomma spp., Ixodes spp., Latrodectus spp., Loxosceles spp., Neutrombicula autumnalis, Nuphersa spp., Oligonychus spp., for example Oligonychus coffeae, Oligonychus coniferarum, Oligonychus ilicis, Oligonychus indicus, Oligonychus mangiferus, Oligonychus pratensis, Oligonychus punicae, Oligonychus yothersi, Ornithodorus spp., Ornithonyssus spp., Panonychus spp., for example Panonychus citri (=Metatetranychus citri), Panonychus ulmi (=Metatetranychus ulmi), Phyllocoptruta oleivora, Platytetranychus multidigituli, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., for example Tarsonemus confusus, Tarsonemus pallidus, Tetranychus spp., for example Tetranychus canadensis, Tetranychus cinnabarinus, Tetranychus turkestani, Tetranychus urticae, Trombicula alfreddugesi, Vaejovis spp., Vasates lycopersici; from the class of the Chilopoda, for example Geophilus spp., Scutigera spp.;

from the order or the class of the Collembola, for example Onychiurus armatus; Sminthurus viridis; from the class of the Diplopoda, for example Blaniulus guttulatus;

from the class of the Insecta, for example from the order of the Blattodea, for example Blatta orientalis, Blattella asahinai, Blattella germanica, Leucophaea maderae, Loboptera decipiens, Neostylopyga rhombifolia, Panchlora spp., Parcoblatta spp., Periplaneta spp., for example Periplaneta americana, Periplaneta australasiae, Pycnoscelus surinamensis, Supella longipalpa;

from the order of the Coleoptera, for example Acalymma vittatum, Acanthoscelides obtectus, Adoretus spp., Aethina tumida, Agelastica alni, Agrilus spp., for example Agrilus planipennis, Agrilus coxalis, Agrilus bilineatus, Agrilus anxius, Agriotes spp., for example Agriotes linneatus, Agriotes mancus, Alphitobius diaperinus, Amphimallon solstitialis, Anobium punctatum, Anoplophora spp., for example Anoplophora glabripennis, Anthonomus spp., for example Anthonomus grandis, Anthrenus spp., Apion spp., Apogonia spp., Atomaria spp., for example Atomaria linearis, Attagenus spp., Baris caerulescens, Bruchidius obtectus, Bruchus spp., for example Bruchus pisorum, Bruchus rufimanus, Cassida spp., Cerotoma trifurcata, Ceutorrhynchus spp., for example Ceutorrhynchus assimilis, Ceutorrhynchus quadridens, Ceutorrhynchus rapae, Chaetocnema spp., for example Chaetocnema confinis, Chaetocnema denticulata, Chaetocnema ectypa, Cleonus mendicus, Conoderus spp., Cosmopolites spp., for example Cosmopolites sordidus, Costelytra zealandica, Ctenicera spp., Curculio spp., for example Curculio caryae, Curculio caryatrypes, Curculio obtusus, Curculio sayi, Cryptolestes ferrugineus, Cryptolestes pusillus, Cryptorhynchus lapathi, Cryptorhynchus mangiferae, Cylindrocopturus spp., Cylindrocopturus adspersus, Cylindrocopturus furnissi, Dendroctonus spp., for example Dendroctonus ponderosae, Dermestes spp., Diabrotica spp., for example Diabrotica balteata, Diabrotica barberi, Diabrotica undecimpunctata howardi, Diabrotica undecimpunctata undecimpunctata, Diabrotica virgifera virgifera, Diabrotica virgifera zeae, Dichocrocis spp., Dicladispa armigera, Diloboderus spp., Epicaerus spp., Epilachna spp., for example Epilachna borealis, Epilachna varivestis, Epitrix spp., for example Epitrix cucumeris, Epitrix fuscula, Epitrix hirtipennis, Epitrix subcrinita, Epitrix tuberis, Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., for example Hypothenemus hampei, Hypothenemus obscurus, Hypothenemus pubescens, Lachnosterna consanguinea, Lasioderma serricorne, Latheticus oryzae, Lathridius spp., Lema spp., Leptinotarsa decemlineata, Leucoptera spp., for example Leucoptera coffeella, Limonius ectypus, Lissorhoptrus oryzophilus, Listronotus (=Hyperodes) spp., Lixus spp., Luperodes spp., Luperomorpha xanthodera, Lyctus spp., Megacyllene spp., for example Megacyllene robiniae, Megascelis spp., Melanotus spp., for example Melanotus longulus oregonensis, Meligethes aeneus, Melolontha spp., for example Melolontha melolontha, Migdolus spp., Monochamus spp., Naupactus xanthographus, Necrobia spp., Neogalerucella spp., Niptus hololeucus, Oryctes rhinoceros, Oryzaephilus surinamensis, Oryzaphagus oryzae, Otiorhynchus spp., for example Otiorhynchus cribricollis, Otiorhynchus ligustici, Otiorhynchus ovatus, Otiorhynchus rugosostriarus, Otiorhynchus sulcatus, Oulema spp., for example Oulema melanopus, Oulema oryzae, Oxycetonia jucunda, Phaedon cochleariae, Phyllophaga spp., Phyllophaga helleri, Phyllotreta spp., for example Phyllotreta armoraciae, Phyllotreta pusilla, Phyllotreta ramosa, Phyllotreta striolata, Popillia japonica, Premnotrypes spp., Prostephanus truncatus, Psylliodes spp., for example Psylliodes affinis, Psylliodes chrysocephala, Psylliodes punctulata, Ptinus spp., Rhizobius ventralis, Rhizopertha dominica, Rhynchophorus spp., Rhynchophorus ferrugineus, Rhynchophorus palmarum, Scolytus spp., for example Scolytus multistriatus, Sinoxylon perforans, Sitophilus spp., for example Sitophilus granarius, Sitophilus linearis, Sitophilus oryzae, Sitophilus zeamais, Sphenophorus spp., Stegobiumpaniceum, Sternechus spp., for example Sternechus paludatus, Symphyletes spp., Tanymecus spp., for example Tanymecus dilaticollis, Tanymecus indicus, Tanymecus palliatus, Tenebrio molitor, Tenebrioides mauretanicus, Tribolium spp., for example Tribolium audax, Tribolium castaneum, Tribolium confusum, Trogoderma spp., Tychius spp., Xylotrechus spp., Zabrus spp., for example Zabrus tenebrioides;

from the order of the Dermaptera, for example Anisolabis maritime, Forficula auricularia, Labidura riparia;

from the order of the Diptera, for example Aedes spp., for example Aedes aegypti, Aedes albopictus, Aedes sticticus, Aedes vexans, Agromyza spp., for example Agromyza frontella, Agromyza parvicornis, Anastrepha spp., Anopheles spp., for example Anopheles quadrimaculatus, Anopheles gambiae, Asphondylia spp., Bactrocera spp., for example Bactrocera cucurbitae, Bactrocera dorsalis, Bactrocera oleae, Bibio hortulanus, Calliphora erythrocephala, Calliphora vicina, Ceratitis capitata, Chironomus spp., Chrysomya spp., Chrysops spp., Chrysozona pluvialis, Cochliomya spp., Contarinia spp., for example Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., for example Culex pipiens, Culex quinquefasciatus, Culicoides spp., Culiseta spp., Cuterebra spp., Dacus oleae, Dasineura spp., for example Dasineura brassicae, Delia spp., for example Delia antiqua, Delia coarctata, Delia florilega, Delia platura, Delia radicum, Dermatobia hominis, Drosophila spp., for example Drosphila melanogaster, Drosophila suzukii, Echinocnemus spp., Euleia heraclei, Fannia spp., Gasterophilus spp., Glossina spp., Haematopota spp., Hydrellia spp., Hydrellia griseola, Hylemya spp., Hippobosca spp., Hypoderma spp., Liriomyza spp., for example Liriomyza brassicae, Liriomyza huidobrensis, Liriomyza sativae, Lucilia spp., for example Lucilia cuprina, Lutzomyia spp., Mansonia spp., Musca spp., for example Musca domestica, Musca domestica vicina, Oestrus spp., Oscinella frit, Paratanytarsus spp., Paralauterborniella subcincta, Pegomya or Pegomyia spp., for example Pegomya betae, Pegomya hyoscyami, Pegomya rubivora, Phlebotomus spp., Phorbia spp., Phormia spp., Piophila casei, Platyparea poeciloptera, Prodiplosis spp., Psila rosae, Rhagoletis spp., for example Rhagoletis cingulata, Rhagoletis completa, Rhagoletis fausta, Rhagoletis indifferens, Rhagoletis mendax, Rhagoletis pomonella, Sarcophaga spp., Simulium spp., for example Simulium meridionale, Stomoxys spp., Tabanus spp., Tetanops spp., Tipula spp., for example Tipula paludosa, Tipula simplex, Toxotrypana curvicauda;

from the order of the Hemiptera, for example Acizzia acaciaebaileyanae, Acizzia dodonaeae, Acizzia uncatoides, Acrida turrita, Acyrthosipon spp., for example Acyrthosiphon pisum, Acrogonia spp., Aeneolamia spp., Agonoscena spp., Aleurocanthus spp., Aleyrodes proletella, Aleurolobus barodensis, Aleurothrixus floccosus, Allocaridara malayensis, Amrasca spp., for example Amrasca bigutulla, Amrasca devastans, Anuraphis cardui, Aonidiella spp., for example Aonidiella aurantii, Aonidiella citrina, Aonidiella inornata, Aphanostigma piri, Aphis spp., for example Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis viburniphila, Arboridia apicalis, Arytainilla spp., Aspidiella spp., Aspidiotus spp., for example Aspidiotus nerii, Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., for example Cacopsylla pyricola, Calligypona marginata, Capulinia spp., Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus aonidum, Chrysomphalus ficus, Cicadulina mbila, Coccomytilus halli, Coccus spp., for example Coccus hesperidum, Coccus longulus, Coccus pseudomagnoliarum, Coccus viridis, Cryptomyzus ribis, Cryptoneossa spp., Ctenarytaina spp., Dalbulus spp., Dialeurodes chittendeni, Dialeurodes citri, Diaphorina citri, Diaspis spp., Diuraphis spp., Doralis spp., Drosicha spp., Dysaphis spp., for example Dysaphis apiifolia, Dysaphis plantaginea, Dysaphis tulipae, Dysmicoccus spp., Empoasca spp., for example Empoasca abrupta, Empoasca fabae, Empoasca maligna, Empoasca solana, Empoasca stevensi, Eriosoma spp., for example Eriosoma americanum, Eriosoma lanigerum, Eriosoma pyricola, Erythroneura spp., Eucalyptolyma spp., Euphyllura spp., Euscelis bilobatus, Ferrisia spp., Fiorinia spp., Furcaspis oceanica, Geococcus coffeae, Glycaspis spp., Heteropsylla cubana, Heteropsylla spinulosa, Homalodisca coagulata, Hyalopterus arundinis, Hyalopterus pruni, Icerya spp., for example Icerya purchasi, Idiocerus spp., Idioscopus spp., Laodelphax striatellus, Lecanium spp., for example Lecanium corni (=Parthenolecanium corni), Lepidosaphes spp., for example Lepidosaphes ulmi, Lipaphis erysimi, Lopholeucaspis japonica, Lycorma delicatula, Macrosiphum spp., for example Macrosiphum euphorbiae, Macrosiphum lilii, Macrosiphum rosae, Macrosteles facifrons, Mahanarva spp., Melanaphis sacchari, Metcalfiella spp., Metcalfa pruinosa, Metopolophium dirhodum, Monellia costalis, Monelliopsis pecanis, Myzus spp., for example Myzus ascalonicus, Myzus cerasi, Myzus ligustri, Myzus ornatus, Myzus persicae, Myzus nicotianae, Nasonovia ribisnigri, Neomaskellia spp., Nephotettix spp., for example Nephotettix cincticeps, Nephotettix nigropictus, Nettigoniclla spectra, Nilaparvata lugens, Oncometopia spp., Orthezia praelonga, Oxya chinensis, Pachypsylla spp., Parabemisia myricae, Paratrioza spp., for example Paratrioza cockerelli, Parlatoria spp., Pemphigus spp., for example Pemphigus bursarius, Pemphigus populivenae, Peregrinus maidis, Perkinsiella spp., Phenacoccus spp., for example Phenacoccus madeirensis, Phloeomyzus passerinii, Phorodon humuli, Phylloxera spp., for example Phylloxera devastatrix, Phylloxera notabilis, Pinnaspis aspidistrae, Planococcus spp., for example Planococcus citri, Prosopidopsylla flava, Protopulvinaria pyriformis, Pseudaulacaspis pentagona, Pseudococcus spp., for example Pseudococcus calceolariae, Pseudococcus comstocki, Pseudococcus longispinus, Pseudococcus maritimus, Pseudococcus viburni, Psyllopsis spp., Psylla spp., for example Psylla buxi, Psylla mali, Psylla pyri, Pteromalus spp., Pulvinaria spp., Pyrilla spp., Quadraspidiotus spp., for example Quadraspidiotus juglansregiae, Quadraspidiotus ostreaeformis, Quadraspidiotus perniciosus, Quesada gigas, Rastrococcus spp., Rhopalosiphum spp., for example Rhopalosiphum maidis, Rhopalosiphum oxyacanthae, Rhopalosiphum padi, Rhopalosiphum rufiabdominale, Saissetia spp., for example Saissetia coffeae, Saissetia miranda, Saissetia neglecta, Saissetia oleae, Scaphoideus titanus, Schizaphis graminum, Selenaspidus articulatus, Sipha flava, Sitobion avenae, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., for example Toxoptera aurantii, Toxoptera citricidus, Trialeurodes vaporariorum, Trioza spp., for example Trioza diospyri, Typhlocyba spp., Unaspis spp., Viteus vitifolii, Zygina spp.;

from the suborder of the Heteroptera, for example Aelia spp., Anasa tristis, Antestiopsis spp., Boisea spp., Blissus spp., Calocoris spp., Campylomma livida, Cavelerius spp., Cimex spp., for example Cimex adjunctus, Cimex hemipterus, Cimex lectularius, Cimex pilosellus, Collaria spp., Creontiades dilutus, Dasynus piperis, Dichelops furcatus, Diconocoris hewetti, Dysdercus spp., Euschistus spp., for example Euschistus heros, Euschistus servus, Euschistus tristigmus, Euschistus variolarius, Eurydema spp., Eurygaster spp., Halyomorpha halys, Heliopeltis spp., Horcias nobilellus, Leptocorisa spp., Leptocorisa varicornis, Leptoglossus occidentalis, Leptoglossus phyllopus, Lygocoris spp., for example Lygocoris pabulinus, Lygus spp., for example Lygus elisus, Lygus hesperus, Lygus lineolaris, Macropes excavatus, Megacopta cribraria, Miridae, Monalonion atratum, Nezara spp., for example Nezara viridula, Nysius spp., Oebalus spp., Pentomidae, Piesma quadrata, Piezodorus spp., for example Piezodorus guildinii, Psallus spp., Pseudacysta persea, Rhodnius spp., Sahlbergella singularis, Scaptocoris castanea, Scotinophora spp., Stephanitis nashi, Tibraca spp., Triatoma spp.;

from the order of the Hymenoptera, for example Acromyrmex spp., Athalia spp., for example Athalia rosae, Atta spp., Camponotus spp., Dolichovespula spp., Diprion spp., for example Diprion similis, Hoplocampa spp., for example Hoplocampa cookei, Hoplocampa testudinea, Lasius spp., Linepithema (Iridiomyrmex) humile, Monomorium pharaonis, Paratrechina spp., Paravespula spp., Plagiolepis spp., Sirex spp., for example Sirex noctilio, Solenopsis invicta, Tapinoma spp., Technomyrmex albipes, Urocerus spp., Vespa spp., for example Vespa crabro, Wasmannia auropunctata, Xeris spp.;

from the order of the Isopoda, for example Armadillidium vulgare, Oniscus asellus, Porcellio scaber;

from the order of the Isoptera, for example Coptotermes spp., for example Coptotermes formosanus, Cornitermes cumulans, Cryptotermes spp., Incisitermes spp., Kalotermes spp., Microtermes obesi, Nasutitermes spp., Odontotermes spp., Porotermes spp., Reticulitermes spp., for example Reticulitermes flavipes, Reticulitermes hesperus;

from the order of the Lepidoptera, for example Achroia grisella, Acronicta major, Adoxophyes spp., for example Adoxophyes orana, Aedia leucomelas, Agrotis spp., for example Agrotis segetum, Agrotis ipsilon, Alabama spp., for example Alabama argillacea, Amyelois transitella, Anarsia spp., Anticarsia spp., for example Anticarsia gemmatalis, Argyroploce spp., Autographa spp., Barathra brassicae, Blastodacna atra, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., for example Chilo plejadellus, Chilo suppressalis, Choreutis pariana, Choristoneura spp., Chrysodeixis chalcites, Clysia ambiguella, Cnaphalocerus spp., Cnaphalocrocis medinalis, Cnephasia spp., Conopomorpha spp., Conotrachelus spp., Copitarsia spp., Cydia spp., for example Cydia nigricana, Cydia pomonella, Dalaca noctuides, Diaphania spp., Diparopsis spp., Diatraea saccharalis, Dioryctria spp., for example Dioryctria zimmermani, Earias spp., Ecdytolopha aurantium, Elasmopalpus lignosellus, Eldana saccharina, Ephestia spp., for example Ephestia elutella, Ephestia kuehniella, Epinotia spp., Epiphyas postvittana, Erannis spp., Erschoviella musculana, Etiella spp., Eudocima spp., Eulia spp., Eupoecilia ambiguella, Euproctis spp., for example Euproctis chrysorrhoea, Euxoa spp., Feltia spp., Galleria mellonella, Gracillaria spp., Grapholitha spp., for example Grapholita molesta, Grapholita prunivora, Hedylepta spp., Helicoverpa spp., for example Helicoverpa armigera, Helicoverpa zea, Heliothis spp., for example Heliothis virescens, Hofmannophila pseudospretella, Homoeosoma spp., Homona spp., Hyponomeuta padella, Kakivoria flavofasciata, Lampides spp., Laphygma spp., Laspeyresia molesta, Leucinodes orbonalis, Leucoptera spp., for example Leucoptera coffeella, Lithocolletis spp., for example Lithocolletis blancardella, Lithophane antennata, Lobesia spp., for example Lobesia botrana, Loxagrotis albicosta, Lymantria spp., for example Lymantria dispar, Lyonetia spp., for example Lyonetia clerkella, Malacosoma neustria, Maruca testulalis, Mamestra brassicae, Melanitis leda, Mocis spp., Monopis obviella, Mythimna separata, Nemapogon cloacellus, Nymphula spp., Oiketicus spp., Omphisa spp., Operophtera spp., Oria spp., Orthaga spp., Ostrinia spp., for example Ostrinia nubilalis, Panolis flammea, Parnara spp., Pectinophora spp., for example Pectinophora gossypiella, Perileucoptera spp., Phthorimaea spp., for example Phthorimaea operculella, Phyllocnistis citrella, Phyllonorycter spp., for example Phyllonorycter blancardella, Phyllonorycter crataegella, Pieris spp., for example Pieris rapae, Platynota stultana, Plodia interpunctella, Plusia spp., Plutella xylostella (=Plutella maculipennis), Podesia spp., for example Podesia syringae, Prays spp., Prodenia spp., Protoparce spp., Pseudaletia spp., for example Pseudaletia unipuncta, Pseudoplusia includens, Pyrausta nubilalis, Rachiplusia nu, Schoenobius spp., for example Schoenobius bipunctifer, Scirpophaga spp., for example Scirpophaga innotata, Scotia segetum, Sesamia spp., for example Sesamia inferens, Sparganothis spp., Spodoptera spp., for example Spodoptera eradiana, Spodoptera exigua, Spodoptera frugiperda, Spodoptera praefica, Stathmopoda spp., Stenoma spp., Stomopteryx subsecivella, Synanthedon spp., Tecia solanivora, Thaumetopoea spp., Thermesia gemmatalis, Tinea cloacella, Tinea pellionella, Tineola bisselliella, Tortrix spp., Trichophaga tapetzella, Trichoplusia spp., for example Trichoplusia ni, Tryporyza incertulas, Tuta absoluta, Virachola spp.;

from the order of the Orthoptera or Saltatoria, for example Acheta domesticus, Dichroplus spp., Gryllotalpa spp., for example Gryllotalpa gryllotalpa, Hieroglyphus spp., Locusta spp., for example Locusta migratoria, Melanoplus spp., for example Melanoplus devastator, Paratlanticus ussuriensis, Schistocerca gregaria;

from the order of the Phthiraptera, for example Damalinia spp., Haematopinus spp., Linognathus spp., Pediculus spp., Phylloxera vastatrix, Phthirus pubis, Trichodectes spp.;

from the order of the Psocoptera, for example Lepinotus spp., Liposcelis spp.;

from the order of the Siphonaptera, for example, Ceratophyllus spp., Ctenocephalides spp., for example Ctenocephalides canis, Ctenocephalides felis, Pulex irritans, Tunga penetrans, Xenopsylla cheopis;

from the order of the Thysanoptera, for example Anaphothrips obscurus, Baliothrips biformis, Chaetanaphothrips leeuweni, Drepanothrips reuteri, Enneothrips flavens, Frankliniella spp., for example Frankliniella fusca, Frankliniella occidentalis, Frankliniella schultzei, Frankliniella tritici, Frankliniella vaccinii, Frankliniella williamsi, Haplothrips spp., Heliothrips spp., Hercinothrips femoralis, Kakothrips spp., Rhipiphorothrips cruentatus, Scirtothrips spp., Taeniothrips cardamomi, Thrips spp., for example Thrips palmi, Thrips tabaci;

from the order of the Zygentoma (=Thysanura), for example Ctenolepisma spp., Lepisma saccharina, Lepismodes inquilinus, Thermobia domestica;

from the class of the Symphyla, for example Scutigerella spp., for example Scutigerella immaculata;

pests from the phylum of the Mollusca, for example from the class of the Bivalvia, for example Dreissena spp.,
and also from the class of the Gastropoda, for example Arion spp., for example Arion ater rufus, Biomphalaria spp., Bulinus spp., Deroceras spp., for example Deroceras laeve, Galba spp., Lymnaea spp., Oncomelania spp., Pomacea spp., Succinea spp.;

plant pests from the phylum of the Nematoda, i.e. phytoparasitic nematodes, in particular Aglenchus spp., for example Aglenchus agricola, Anguina spp., for example Anguina tritici, Aphelenchoides spp., for example Aphelenchoides arachidis, Aphelenchoides fragariae, Belonolaimus spp., for example Belonolaimus gracilis, Belonolaimus longicaudatus, Belonolaimus nortoni, Bursaphelenchus spp., for example Bursaphelenchus cocophilus, Bursaphelenchus eremus, Bursaphelenchus xylophilus, Cacopaurus spp., for example Cacopaurus pestis, Criconemella spp., for example Criconemella curvata, Criconemella onoensis, Criconemella ornata, Criconemella rusium, Criconemella xenoplax (=Mesocriconema xenoplax), Criconemoides spp., for example Criconemoides ferniae, Criconemoides onoense, Criconemoides ornatum, Ditylenchus spp., for example Ditylenchus dipsaci, Dolichodorus spp., Globodera spp., for example Globodera pallida, Globodera rostochiensis, Helicotylenchus spp., for example Helicotylenchus dihystera, Hemicriconemoides spp., Hemicycliophora spp., Heterodera spp., for example Heterodera avenae, Heterodera glycines, Heterodera schachtii, Hirschmaniella spp., Hoplolaimus spp., Longidorus spp., for example Longidorus africanus, Meloidogyne spp., for example Meloidogyne chitwoodi, Meloidogyne fallax, Meloidogyne hapla, Meloidogyne incognita, Meloinema spp., Nacobbus spp., Neotylenchus spp., Paralongidorus spp., Paraphelenchus spp., Paratrichodorus spp., for example Paratrichodorus minor, Paratylenchus spp., Pratylenchus spp., for example Pratylenchus penetrans, Pseudohalenchus spp., Psilenchus spp., Punctodera spp., Quinisulcius spp., Radopholus spp., for example Radopholus citrophilus, Radopholus similis, Rotylenchulus spp., Rotylenchus spp., Scutellonema spp., Subanguina spp., Trichodorus spp., for example Trichodorus obtusus, Trichodorus primitivus, Tylenchorhynchus spp., for example Tylenchorhynchus annulatus, Tylenchulus spp., for example Tylenchulus semipenetrans, Xiphinema spp., for example Xiphinema index.

In a preferred embodiment the term “pesticide” according to the present invention refers to an “insecticide”.

The term “insecticide” as used according to the invention refers to the capacity of a substance to kill or cause a knockdown of an insect.

In another preferred embodiment the insecticide according to the invention is used to control:
flies such as filth flies or housefly and its relatives (Muscidae); flesh flies (Sarcophagidae); bottle flies and blowflies (Calliphoridae); black flies (Simuliidae); horseflies and deer flies (Tabanidae), fruit flies (Drosophilidae),
insects from the order of the Zygentoma (=Thysanura), for example Ctenolepisma spp., Lepisma saccharina, Lepismodes inquilinus, Thermobia domestica;
insects form the order of the Hemiptera, for example aphids and whiteflies etc.

In order to control the pests and preferably the target insects indicated above it is preferred to apply the cationic polysaccharide compounds of the invention directly on the pests resp. the target insects e.g. with a direct spray application.

“Target insect,” as that term is used herein, is an insect that is naturally attracted to the area of interest and for which it is desired to implement a measure of population control. The term “target insect” encompasses the insect at all stages of development and its offspring, including the mature insect, eggs, pupae stage, and larvae.

The term “algaecide” according to the invention refers to characteristics of the cationic polysaccharide compounds of the invention to curatively or preventively control algae and/or moss growth.

Another embodiment of the invention relates to the use of the cationic polysaccharide compounds according to the invention as a (preferably preharvest) dessicant or defoliant. This refers to the capability of the cationic polysaccharide compounds of the invention to dry up, cause to dry up, deprive, or exhaust the moisture in certain crops such as maize, cereals, oilseed rapes, legumes, potatoes, cotton.

Another embodiment relates to the use of the cationic polysaccharide compounds of the invention to extend the shelf life of fruits and vegetables. In this context it is preferred that the cationic polysaccharide compounds of the invention are applied to the crop prior to the harvest of the fruits and vegetables, however, postharvest applications are also possible. For this purpose the fruits are preferably selected from the group consisting of banana, blackcurrant, redcurrant, gooseberry, tomato, eggplant, guava, lucuma, chili pepper, pomegranate, kiwifruit, grape, table grapes pumpkin, gourd, cucumber, melon, orange, lemon, lime, grapefruit, cranberry, blueberry, blackberry, raspberry, boysenberry, hedge apple, pineapple, fig, mulberry, apple, apricot, peach, cherry, sunflower seed, strawberry and plum. For this purpose the vegetables are preferably selected from the group consisting of broccoli, green bean, lettuce, cauliflower, globe artichokes, sweetcorn, maize, kale, collard greens, spinach, beet greens, turnip greens, endive; leeks, Brussels sprouts, celery, rhubarb, asparagus, ginger; potatoes, Jerusalem artichokes, sweet potato, yarn bean sprouts, carrots, parsnips, beets, radishes, turnips, onions, garlic, shallots.

Independent of the use of the cationic polysaccharide compounds of the invention the application rates can be varied within a broad range, depending on the type of application. For foliar applications the application rates are generally ranging from 1 to 50 liter/ha, more preferably from 5 to 30 liter/ha, most preferably from 7 to 20 liter/ha based upon the pure a.s. (active substance). When used on plants the cationic polysaccharide compounds of the invention can be applied to all parts of the plants such as shoot, leaf, flower and root, leaves, needles, stalks, stems, flowers, vegetative buds and flower buds fruiting bodies and fruits.

In a preferred embodiment the terms “extending the shelf life” refers to a period of at least 1 day, preferably at least 2 days, even more preferably at least 1 week wherein the overall quality of a fruit and/or vegetable can be maintained in comparison to an untreated fruit and/or vegetable.

The treatment of the plants and pests is carried out directly by the customary treatment methods, for example by spraying, immersion, vaporizing, fogging, injecting, dripping, drenching, broadcasting or painting.

In a preferred embodiment of the invention the cationic polysaccharide compounds of the invention are applied via spraying.

The cationic polysaccharide compounds of the invention can be converted to customary formulations, such as solutions, emulsions, suspensions, powders, foams, pastes, granules, aerosols, very fine capsules in polymeric substances and in coating compositions for seed, and also ULV cold- and warm-fogging formulations. These formulations are produced in a known manner.

### EXAMPLES

### Example 1

Method: Cucumber plants were planted in pots and reared on tables in a greenhouse with fully controlled climatic conditions. The trial was randomised with 2 replicates and 3 plants per plot, following GEP standards. Of each plant one leaf on the upper leaf level was chosen for treatment for uniformity of size, age, vigour and health by optical appearance. Each of these leaves was treated once with the test sample applied to the whole upper leaf surface. Aqueous concentrates of cationic polymer and their spray solutions were prepared having the following compositions:

Table 1-1
Tested formulations.

| | Active | | | | | | |
|---|---|---|---|---|---|---|---|
| Product/ | matter in | | Formulation (=FL); (w/w %) | | | | |
| Component | component | Supplier | FL1 | FL 2 | FL 3 | FL 4 | FL 5 |
| Chitosan | 1 | Sigma- | 1.0 | 0 | 0 | 0 | 0 |
| (medium MW | | Aldrich | | | | | |
| product; | | | | | | | |
| 50-190 kD) | | | | | | | |
| Lupasol ® HF | 56 | BASF | 0 | 50 | 0 | 0 | 0 |
| Quatin ® 350 | 40 | COSUN | 0 | 0 | 50 | 0 | 0 |
| TQ | | Biobased | | | | | |
| | | Products | | | | | |
| Quatin ® 680 | 40 | COSUN | 0 | 0 | 0 | 50 | 0 |
| TQ | | Biobased | | | | | |
| | | Products | | | | | |
| Quatin ® 1280 | 35 | COSUN | 0 | 0 | 0 | 0 | 50 |
| TQ | | Biobased | | | | | |
| | | Products | | | | | |
| Water | | | 99 | 50 | 50 | 50 | 50 |
| Sum | | | 100 | 100 | 100 | 100 | 100 |
| pH | | | 4.3* | 7.5* | 4.6 | 4.6 | 4.1 |
| Dilution rate to | | | 50 | 50 | 50 | 50 | 50 |
| prepare spray | | | | | | | |
| solution (ml/l) | | | | | | | |

*pH adjusted with acetic acid

Due to increase of viscosity, handling of chitosan solutions with an active matter content significantly larger than 1 w/w % is difficult. Moreover, application volumes are limited in practice. Therefore we have chosen to apply as a reference a 1% chitosan solution to be applied also at the same volume rate as the other concentrates.

Quatin samples of commercially available cationic inulin (hydroxypropyl trimonium inulin) were obtained from of Cosun Biobased products.

For reference, a commercial aqueous solution of cationic polyethyleneimine (Lupasol® HF) was obtained from BASF.

For better coverage of the leaf surface all concentrates in table 1-1 were tank-mixed with the commercial wetting agent Breakthru® S240 (a polyalkyleneoxide modified peptamethyltrisiloxane from Evonik) with a rate of 0.1 ml/L to obtain the spray solution. Breakthru® S240 was also tested on its own. That is without a test product as mixing partner. A commercial sulphur based and contact active product (SUFRAN JET® WG 80) was employed as a bench mark with its recommended rate. The spray solution was prepared by diluting the recommended amount in tap water (1.5 g/L). The spray solutions were applied with a manual pump sprayer with a spray volume of 1000 L/ha to visible coverage of the upper leaf surface. Leaves were treated with the test samples prior to inoculation with a fungal pathogen. 24 hours after the application one half side along the middle vein of each treated leaf was artificially inoculated with spores of Powdery Mildew (Sphaerotheca fuliginea) at a density of 10000 spores/ml.

The inoculated leaf side was assessed visually 11 days after inoculation for % leaf area showing mycelium growth. The % control was calculated using the formula of Abbott (ABBOTT, W. S. (1925): A method of computing the effectiveness of an insecticide. Journal of economic Entomology, 18, 265-267).

Control %=(1−(value in treated/value in untreated))*100

The tank mix component Breakthru S240 alone (treatment line 2) had did not provide any control of the development of the fungal pathogen. The test samples FL2, FL3, FL4, F16—each combined with the tankmix components Breakthru S240—achieved control levels of 100%, 70%, 97% and 97%, respectively. The commercial reference product (Sufran Jet WG 80) provided 100% control. These results are presented in Table 1-2.

TABLE 1-2
Efficacy of test samples against Powdery Mildew on Cucumber

| | | % Control (Abbott) |
|---|---|---|
| FL | Product/Component | 11 days after inoculation |
| — | UNTREATED | 5.6% infested leaf area |
| — | BREAK THRU S 240 | 0 |
| FL 1 | Chitosan (medium MW product) | 0 |
| FL 2 | LUPASOL ® HF | 100 |
| FL 3 | QUATIN ® 350 TQ | 70 |
| FL 4 | QUATIN ® 680 TQ | 97 |
| FL 6 | QUATIN ® 1280 TQ | 97 |
| — | SUFRAN JET WG 80 | 100 |

All Quatin products had an inhibiting effect on the development of the fungal pathogen on the treated leaf area when applied in a protective timing. In some cases, the inhibiting effect was similar to a proven contact acting reference product. Test samples inhibited the development of the fungus, thus functioned protectively. The efficacy cannot attributed to the wetting agent Breakthru S240, since applied on its own, this product has no efficacy. The fungicidal activity of cationic inulin is surprising since, based on its chemistry, not expected and not known yet.

### Example 2

Method: Cucumber plants were planted in pots and reared on tables in a greenhouse with fully controlled climatic conditions. The trial was randomised with 4 replicates and 3 plants per plot, following GEP standards. Of each plant one leaf on the upper leaf level was chosen for treatment for uniformity of size, age, vigour and health by optical appearance. On each of these leaves one half side along the middle vein of the upper leaf surface was treated with a test sample. The other half side was covered during application, thus not treated and served as untreated control. A second application in the same manner as the first was applied once the 1^{st} spray had dried. This was for the purpose of a more complete coverage of the treated leaf surface with active material.

Following test samples from example 1 and dilutions rates to obtain the spray solution were selected for testing:

TABLE 2-1
Tested formulations.

| Formulations: | FL 2 | FL 3 | FL 4 |
|---|---|---|---|
| Active matter | Lupasol ® HF | Quatin ® 350 TQ | Quatin ® 680 TQ |
| Dilution rate to | 50 | 50 | 25 |
| prepare spray | | | |
| solution (ml/l) | | | |

For better coverage of the leaf surface all concentrates were tank-mixed with the commercial wetting agent Breakthru® S240 (Evonik), but this time with a rate of 0.05 ml/L to obtain the spray solution. Breakthru® S240 was also tested on its own. That is without a test product as mixing partner.

In a similar way as in example 1, Lupasol® HF and SUFRAN JET® WG 80 were chosen as references. In this example, the spray solution of SUFRAN JET® WG 80 was prepared by diluting 1.0 g/L product in tap water. The spray solutions were applied with a manual pump sprayer with a spray volume of 1000 L/ha to visible coverage of the upper leaf surface. 24 hours after the 2nd applications each of the treated leaves—the whole upper leaf surface—was artificially inoculated with spores of Powdery Mildew (Sphaerotheca fuliginea) at a density of 100000 spores/ml. The treated leaf area was assessed visually 8 and 13 days after the day of inoculation as % leaf area covered with mycelium. These results are presented in Table 2-2.

TABLE 2-2
Efficacy of test samples against Powdery Mildew on Cucumber

| | | % Control | % Control | % Control |
|---|---|---|---|---|
| | | (Abbott) | (Abbott) | (Abbott) |
| | | 8 days after | 13 days after | 21 days after |
| FL | Product/Component | inoculation | inoculation | inoculation |
| — | UNTREATED | 35% | 81% | 99% |
| | | infested | infested | infested |
| | | leaf area | leaf area | leaf area |
| — | BREAK THRU S 240 | 44 | 32 | 14 |
| FL 2 | LUPASOL HF + | 98 | 91 | 97 |
| | BREAK THRU S 240 | | | |
| FL 3 | QUATIN 350 TQ + | 90 | 89 | 92 |
| | BREAK THRU S 240 | | | |
| FL 4 | QUATIN 680 TQ + | 98 | 95 | 96 |
| | BREAK THRU S 240 | | | |
| — | SUFRAN JET | 100 | 100 | 100 |

The trial in example 2 showed strong disease pressure with the infested leaf area increasing from 0% at time of application to 35% on day 8 after inoculation to 81% on day 13.

The tank mix component Breakthru S240 alone (treatment line 2) had a minor effect on the development of the fungal pathogen of 44 and 32% control at 8 and 13 days after inoculation, respectively.

The Quatin test samples, however, achieved control levels of 90% and 98% (8 days after inoculation), 89% and 95% (13 days after inoculation), 92% and 96% (21 days after inoculation), respectively.

The commercial reference product (Sufran Jet) provided 100% control at the same dates.

1. A method for controlling fungi, pests, or algae on fruits and/or vegetables: dessicating fruits and/or vegetables: or extending shelf life of fruits and/or vegetables by applying to fruits and/or vegetables a cationic polysaccharide compound which contains, per monosaccharide unit, on average at least 0.1 cationic group of the formula:
-A-N⁺R¹R²R³ or —C(═NR⁴)—NR¹R²
in which formula:
A represents a straight-chain or branched C₂-C₆ alkylene group which is optionally preceded by a carbonyl group or optionally interrupted by one or two oxygen atoms or imino or alkylimino groups and optionally substituted by one or two hydroxyl groups or amine groups or a carboxyl or carbamoyl group; or A represents the residue of a monosaccharide unit;
R¹ and R² each represent hydrogen methyl, carboxymethyl, phosphonomethyl, ethyl, hydroxyethyl, propyl, isopropl, allyl, hydroxypropyl or dihydroxypropyl or, together with the nitrogen atom, form a pyrrolidino, piperidino, piperazino, N′-alkylpiperazino, N′-(hydroxyalkyl)piperazino, N′-(aminoalkyl)piperazino, morpholino or hexamethyleneamino group;
R³ represents hydrogen, C₁-C₁₈ alkyl, C₃-C₁₈ alkenyl, alkynyl or cycloalkyl, C₄-C₁₈ cycloalkyl-alkyl or C₇-C₁₈ aralkyl or a group of the formula -A-Fruc, where A has the above-mentioned meaning and Fruc represents a fructan residue bonded via oxygen; and
R⁴ represents hydrogen, methyl, ethyl, hydroxyethyl, hydroxypropyl or dihydroxypropyl; where the amine nitrogen atoms can be uncharged or protonated or quarternised with methyl, ethyl, hydroxyethyl, hydroxypropyl or dihydroxypropyl;
wherein the polysaccharide compound has a solubility in water of at least 20 wt-% at a temperature of 25° C.

2. The method according to claim 1 wherein the polysaccharide compound is selected from the group consisting of sucrose, trehalose, lactose, fructan, dextran, maltodextrin, amylose and cellulose and wherein each polysaccharide contains, per monosaccharide unit, on average at least 0.1 cationic group of the formula:
-A-N⁺R¹R²R³ or —C(═NR⁴)—NR¹R².

3. The method according to claim 2 wherein the polysaccharide compound is fructan which contains, per monosaccharide unit, on average at least 0.1 cationic group of the formula:
-A-N⁺R¹R²R³.

4. The method according to claim 1, wherein the polysaccharide compound contains, per monosaccharide unit, on average from 0.1 to 2.5, more preferably on average from 0.2 to 2.0 and especially preferred from 0.35 to 1.5 cationic group.

5. The method according to claim 1, wherein the polysaccharide compound is characterized in that A is bonded to an oxygen atom of the monosaccharide unit.

6. The method according to claim 1, wherein the polysaccharide compound is characterized in that R¹ and R² each represent methyl or ethyl.

7. The method according to claim 1, wherein the polysaccharide compound is characterized in that A represents ethylene or 2-hydroxypropylene.

8. The method according to claim 1, wherein the polysaccharide compound is characterized in that R¹, R² and R³ each represent methyl or ethyl.

9. The method according to claim 1, wherein the polysaccharide compound has a degree of polymerization from 2 to 1000, preferably from 3 to 60 and most preferably from 3 to 15 monosaccharide units.

10. The method according to claim 1 wherein the cationic polysaccharide compound curatively or preventively controls a phytopathogenic fungi.

11. The method according to claim 10, wherein the phytopathogenic fungi is an Ascomycota.

12. The method according to claim 10 wherein the phytopathogenic fungi is powdery mildew.

13. The method according to claim 1, wherein the cationic polysaccharide compound controls insects.

14. (canceled)

15. The method according to claim 13, wherein the cationic polysaccharide compound is applied via a spray application.

16. (canceled)
